(19) United States
(12) Patent Application Publication
(10) Pub. No.: US 2011/0072051 A1
(43) Pub. Date: Mar. 24, 2011

(54) PROCEDURE AND DISPOSITIVE ALLOWING THE DISPLAYING OF INFORMATION ASSOCIATED TO ONE OR SEVERAL KEY WORDS ON A COMPUTER SCREEN

(75) Inventors: Rebecca Jane Lyne, Mequon, WI (US); Philippe Gouret, Marseille (FR)

(73) Assignee: Rebecca Jane Lyne, Paris (FR)

(21) Appl. No.: 12/899,247

(22) Filed: Oct. 6, 2010

(30) Foreign Application Priority Data
Apr. 8, 2009 (FR) PCT/FR2009/050611

(51) Int. Cl. G06F 17/30

(52) U.S. Cl. 707/794; 707/706; 707/E17.099; 707/E17.108

(57) ABSTRACT

The invention relates to a process which makes it possible to display on a computer screen information associated with one or more key words and in which:
customers associate information with a word group containing one or more “required” key words selected from a database,
a user selects one or more key words “offered”, chosen from the database,
for each “required” word group, one analyzes the semantic proximity of the words “offered” and of the aforesaid “required” words by calculating a score inversely proportional to the number of connections separating the aforementioned words on an ontology graph, the aforementioned score being calculated by averaging the partial-scores obtained for each “offered” and “required” word pair, the aforementioned partial-scores being calculated according to the following algorithm:
   on each ontology graph, one calculates the topology distance between an “offered” word and a “required” word: d(Wo−Wr),
   if one cannot measure the topological distance then: partial-score=0
   if d(Wo−Wr)<0 then: partial-score=C1/abs[d(Wo−Wr)],
   if d(Wo−Wr)>0 then: partial-score=C2/abs[d(Wo−Wr)],
   if d(Wo−Wr)=0 then: partial-score=1,
   with C1 and C2 two predefined constants such as 0<C1<C2<1,
   the partial-score retained being the best partial-scores calculated on each ontology graph,
one posts information associated with the “required” word group having the highest score.

### TECHNICAL DOMAIN OF THE INVENTION

The objective of the invention is a procedure and dispositive allowing the displaying on a computer screen of information associated to one or several key words.

The objective of the invention is also a system for Internet websites allowing them to put users wishing to participate in events and the hosts organizing said events in contact with one another.

The invention concerns the technical domain of procedures, dispositive or systems allowing the calculation of a score reflecting the semantic proximity between a searched word and a word belonging to a data base. The invention concerns more specifically, but not limited to, the technical domain of advertising and/or publicity on the Internet, targeted by key words.

### STATE OF THE TECHNOLOGY

The functioning of targeted advertising by key words is well known to the profession. Notably the system AdWords® developed by Google®: advertisers target the key words most likely to trigger advertising links that would then be displayed and visible. The targeting allows one to attract new clients at a precise moment or these same possible new clients also search the Internet for products and services containing these key words.

When the user searching on the Internet with the help of a search engine specifies and inputs one or several key words which have previously been chosen by the advertiser, publicity links are then more likely to appear along with the results of the research. These links typically contain a URL address which redirects the Internet user to the website of the advertiser. In practice, a specific program allows the comparison of key words input by users and the key words chosen by advertisers. If at least one key word input by a user is identical to a key word chosen by an advertiser, then the advertising link appears on the screen of said users. When the users click on the link, and only under this condition, the advertisers are debited a certain sum of money.

This type of targeted advertising is particularly advantageous for both the advertiser and the user and today is successful.

However, the method allowing the comparison of key words input by users and the key words chosen by advertisers has a number of limitations. Essentially, this method is generally a syntax comparison based on the layout of letters of the alphabet forming the key words, in other words, it is based on the spelling of the words. So, this means that in certain cases, users see advertising links appearing on their screens which do not actually correspond to the products, services or interests for which they are searching.

For example, since no semantic analysis of the words is carried out, if a user registers the word “ORANGE”, he will most likely see appearing on his screen the advertising links related to the color orange as well as the advertising links relating to companies associated to citrus fruit, the fruit of the orange tree. In this last case, the advertisers have the possibility of using a condition so that their link appears only when the words “FRUIT” and “ORANGE” are registered by the user.

This solution is not particularly satisfactory insofar as the advertiser must combine at least two key words and that in general the tariff applied by Google® is proportional to the number of selected words.

We know based on the existence of the US patent document 6.453.315 (APPLIED SEMANTICS), the procedure for displaying on a computer screen information associated with one or more key words, important in that:

one establishes a database containing key words classified in one or more ontology graph so that the aforementioned words are connected and organized according to semantics, each graph corresponding to a different type of relationship linking the aforementioned key words,

customers associate information with a word group containing one or more key words chosen in the database, these words being known as “required”,

a user selects one or more key words chosen in the database, these words being known as “offered”,

for each “required” word group one analyzes the semantic proximity of the “offered” words and the “required” words by calculating a score inversely proportional to the number of connections separating the aforementioned words on each ontology graph,

one displays information associated with the “required” word group having the highest score, on the user's screen.

However, there is no algorithm making it possible to calculate the score precisely mentioned in this document.

The US patent document 2003/130997 (ENEWOLDSEN) reveals a process to search for a similar case study among a group of case studies, the key words of the case studies being associated with each of the case studies. However, there is no precise algorithm which makes it possible to calculate the semantic proximity between two word groups is mentioned in this document.

The document ARIF BRAMANTORO et Al: [symbol] A Semantic Distance Measure for Matching Web Service [symbol] WEB INFORMATION SYSTEMS ENGINEERING—WISE 2005 WORKSHOPS LECTURE NOTES IN COMPUTER SCIENCE; LNCS, SPRINGER, BERLIN, GERMANY, vol. 3807, Jan. 1, 2005, p. 217-226, reveals a particularly complex algorithm making it possible to calculate the semantic proximity between two word groups.

Considering these facts, the technical problem which this invention aims to solve is to propose a method that makes it possible to easily compare the key words registered by the users and the key words chosen by the advertisers, the comparison being based on an effective and objective analysis of the semantic proximity of the aforesaid key words.

In a more general way, the main aim of the invention is to propose a technique making it possible to display on a computer screen the information associated with one or more key words of which the significance or the actual meaning, is the closest to those of the key words chosen by a user.

### DISCLOSURE OF INVENTION

The solution suggested by the invention is a process to display on a computer screen information associated with one or more key words, characteristic in that:

one establishes a database containing key words classified in one or more ontology graphs so that the aforementioned words are connected and organized according to semantics, each graph corresponding to a different type of relationship linking the aforementioned key words,

customers associate information with a word group containing one or more key words chosen in the database, these words being known as “required”,

a user selects one or more key words chosen in the database, these words being known as “offered”,

for each “required” word group one analyzes the semantic proximity of the “offered” words and of the “required” words by calculating a score inversely proportional to the number of connections separating the aforementioned words on each ontology graph,

one displays information associated with the “required” word group having the highest score, on the user's screen.

The establishment of the ontology graph or graphs makes it possible to put order into the database, not according to the orthography of the words which compose it but according to their actual meaning in a given semantic field. These specific graphs thus make it possible to make a semantic comparison of the words and not just a syntactic comparison as in other existing systems. If one applies this process to the methods of targeted advertising on the Internet, the advertising links (or “information” to use again the terms of the invention) likely to appear next to the results of a search will be more accurately selected and thus more effective than those of the currently used technology in the field today.

The fact of using several ontological graphs allows one to have a richer and more precise ontology. Each graph corresponds to a different type of relationship between key words. Taking two words Wo and Wr, the examples of relationships can be: “Wo is contained in Wr”, “Wr includes Wo”, “Wo is a subcategory of Wr”, “Wo is greater than Wr”, “Wr is lesser than Wo”, etc

According to an advantageous characteristic of the invention, it allows one to take into account the word order needing to be analyzed; one directs the connections between the key words of the ontology graph or graphs according to the direction of the relationship type linking the aforementioned key words. Taking again the example discussed above:
“Wo is contained in Wr” will imply the orientation Wo→Wr;
“Wr includes Wo” will imply the orientation→Wr Wo;
“Wo is a sub-category of Wr” will imply the orientation Wr→Wo;
“Wo is greater than Wr” will imply the orientation Wo→Wr;
“Wr is lesser than Wo” will imply the orientation→Wr Wo.

According to another advantageous characteristic of the invention, making it possible to analyze effectively and objectively the semantic proximity of the key words classified in the ontology graph or graphs, one calculates the score by averaging the partial-score obtained for each word pair of “offered” (Wo) and “required” (Wr), the aforementioned partial-score being calculated according to the following algorithm:

on each ontology graph, one calculates the topology distance between an “offered” word (Wo) and a “required” word (Wr): d(Wo−Wr),
if one cannot measure the topological difference, then: sub-score=0,
if d(Wo−Wr)<0 then: sub-score=C1/abs[d(Wo−Wr)],
if d(Wo−Wr)>0 then: sub-score=C2/abs[d(Wo−Wr)],
if d(Wo−Wr)=0 then: sub-score=1,
with C1 and C2 two predefined constants such as 0<C1<C2<1,
the sub-score retained being the best of the partial-scores calculated on each ontological graph

Preferentially, one averages only non-zero partial-scores so as not to overly penalize the score of customers calculated for each “required” word group.

Another aspect of the invention relates to a dispositive making it possible to display on a computer screen information associated with one or more key words, characteristic in what it comprises:

a database containing the key words classified in one or more ontology graphs so that the aforementioned words are connected and organized amongst themselves according to semantics, each graph corresponding to a different type of relation linking the aforementioned key words,

customers associate information with a word group containing one or more key words chosen in the database, these words being known as “required”,

a configured interface allowing a user to select one or more key words chosen from the database, these words being known as “offered”,

a processor carrying out a computer program which allows, for each “required” word group, the analysis of the semantic proximity of the “offered” words and of the aforesaid “required” words by calculating a score inversely proportional to the number of connections separating the aforementioned words on each ontology graph,

a means to display information associated with the “required” word group having the highest score, on the user's screen.

Another advantageous characteristic of the invention is found in the connections between the key words of the ontology graph which are oriented according to the direction of the type of relationship linking the aforementioned key words.

According to still another advantageous characteristic of the invention, making it possible to realize effectively and quickly the analysis of the semantic proximity of the key words classified in the ontology graphs, the processor calculates the score by carrying out a computer program configured to calculate and average the partial-scores obtained for each word pair of “offered” (Wo) and “required” (Wr) (preferably non zero partial-scores), the aforementioned partial-scores being calculated according to the following algorithm:

on each ontology graph, one calculates the topology distance between an “offered” word (Wo) and a “required” word (Wr): d(Wo−Wr),

if the topological distance is not measurable then: partial-score=0,

if d(Wo−Wr)<0 then: partial-score=C1/abs[d(Wo−Wr)],

if d(Wo−Wr)>0 then: partial-score=C2/abs[d(Wo−Wr)],

if d(Wo−Wr)=0 then: partial-score=1,

with C1 and C2 two predefined constants such as 0<C1<C2<1,

the partial-score retained being the best of the partial-scores calculated on each ontological graph

According to still another characteristic, the device advantageously comprises a configured interface so that the customers and/or the users can supplement the ontology graphs with key words which are not initially present in the database and which are likely to enrich the vocabulary of the semantic field of the database.

According to still another characteristic of the invention, the information posted on the screen is an advertising banner and/or a link directed to an Internet site, and/or a hypertext link, and/or a URL address, and/or a text, and/or an image, and/or a video message, and/or a message audio, and/or an instruction allowing the execution of a program.

According to still another advantageous characteristic of the invention, the ontology graphs are directed acyclic graphs. The fact of not having a cycle on the ontology graph or graphs facilitates the analysis of the semantic proximity of the key words, because this limits the potential descriptiveness and the relations between the said words.

According to still another advantageous characteristic making it possible to avoid any ambiguity of meaning, the key words classified in the ontology graph or graphs have an entirely different syntax.

Still another aspect of the invention relates to an Internet site system making it possible to connect guests wishing to take part in meals or food related event and the hosts wishing to organize the aforementioned meals or events. This Internet site system is exceptional in that it has notably a dispositive conforming to the preceding characteristics and in particular:
a database containing key words in relation to the semantic field of gastronomy, the aforementioned words being classified in one or more ontology graphs so that the aforementioned words are connected and organized amongst themselves according to semantics, each graph corresponding to a different type of relationship linking the aforementioned key words,

a configured interface allowing the hosts to select one or more key words chosen in the database, the aforementioned words being selected to characterize the type of meal or food related event they wish to organize, these words being known as “offered”,

a configured interface allowing the guests to select one or more key words chosen in the database, the aforementioned words being selected to characterize their culinary interests,

customers associate information with a word group containing one or more key words chosen in the database, these words being known as “required”,

a processor executing a computer program allowing:
the analysis of the key words of the guests so as to select the meals or food related events organized by the hosts and characterized by one or more key words chosen by the aforementioned guests,
the analysis, for each “required” word group and for each “offered” word group, of the semantic proximity of the aforesaid words “offered” and of the aforesaid words “required” by calculating a score inversely proportional to the number of connections separating the aforementioned words on each ontology graph,

a means to display, on the computer screen of the guests, the list of the selected meals or food related events, each meal or food related event appearing as a hypertext link returning to a window describing in detail the aforementioned meal or food related event,

a means to display information associated with the “required” word group having the highest score, on the computer screen of the guests having selected a meal or food related event from the list.

Yet another aspect of the invention concerns an Internet site system having notably

a database containing key words in relation to the semantic field of gastronomy, the aforementioned words being classified in one or more ontology graphs so that the aforementioned words are connected and organized amongst themselves according to semantics, each graph corresponding to a different type of relationship linking the aforementioned key words,

a configured interface allowing the hosts to associate a meal or food related event that they wish to organize with a group containing one or more key words chosen in the database, these words being known as “required”,

an interface configured to allow the guests to select one or more key words chosen in the database, the aforementioned words being selected to characterize the type of meal or food related event desired, these words being known as “offered”,

a processor carrying out a computer program allowing the analysis for each “required” word group of the semantic proximity of the “offered” words and of the aforesaid “required” words by calculating a score inversely proportional to the number of connections separating the aforementioned words on each ontology graph,

a means to display, on the computer screen of the guests, the list of the meals or food related events associated with the “required” word groups having a non zero score.

Still another aspect of the invention relates to a search engine comprising a processor which carries out a computer program making it possible to calculate a score reflecting the semantic proximity between two words Wo and Wr,

the latter belonging to a database containing the key words classified in one or more ontology graphs,

the aforementioned ontology graphs being oriented, so that the aforementioned words are organized according to semantics and various relationships linking the aforementioned key words,

the said program calculating the said score according to the following algorithm:
calculate the topological distance of each ontology graph between the said words: d(Wo−Wr)
if the topological distance is not measurable then: score=0,
if d(Wo−Wr)<0 then: score=C1/abs[d(Wo−Wr)],
if d(Wo−Wr)>0 then: score=C2/abs[d(Wo−Wr)],
if d(Wo−Wr)=0 then: score=1,
with C1 and C2, two predefined constants such as 0<C1<C2<1,
the score retained being the best calculated score on each ontology graph

### DESCRIPTION OF FIGURES

Other advantages and characteristics of the invention will better appear with the reading of the description of the preferred realization modes which will follow, in reference to the annexed drawings, and be carried out as indicative and nonrestrictive examples and in which:

image 1 is a schematic representation of an example of the ontology graph,

images 2a and 2b show different types of relationships that can be linked from key words in the ontology graph,

image 3 shows different steps of the score calculation reflecting the semantic proximity of key words belonging to the ontology graph.

### HOW THE INVENTION IS MANIFESTED

Conforming to the invention, a data base is established containing key words belonging to one or several semantic data domains such as: cuisine, art, travel, legal services, etc.

Looking at image 1, these key words are categorized in one or several ontology graphs in such a way that the said key words are organized semantically. “Ontology” means a structured vocabulary allowing the precise description of a specific semantic domain. The entirety of key words and the one or several ontology graphs make up the integral data base and are stored in this data base.

For a grouping of data words, it is possible to have several overlapping ontological graphs each corresponding to a different type of relationship. For example, using four words of “wine”, “cognac”, “beverage” and “alcohol”, it is possible to have three relationships and thus three ontological graphs:

Graph 1 (“is a sub-category of”)
Wine is a sub-category of “beverage”.
Cognac is a sub category of beverage

Graph 2 (“is contained in” “)
Alcohol is contained in wine
Alcohol is contained in cognac

Graph 3 (“is greater than”)
Cognac is greater than wine.

Taking the example of the ontology graph in image 1, the semantic domain is the domain of gastronomy. This graph advantageously offers different categories susceptible to defining by key words the principal contours of the semantic domain approached: “food”, “beverages”, “culinary techniques”, “ambiance”, etc. Each category divides into sub-categories in such a way that it can characterize by other key words each of these said sub-categories. For example, the category “food” can be characterized by key words such as “meat”, “fish”, “poultry”, etc. “Poultry” is a sub-category of “meat” which is a sub-category of “food”. Referring to image 1, one understands that each sub-category can equally divide into other sub-categories each characterized by one or several key words. Therefore one now has a graph organized by semantics and not by syntax. Preferably, the key words in the one or several ontology graphs all have a different syntax, in other words a unique spelling.

In practice, the ontology graph displays on a computer screen preferably in the form of a tree view, with a drop down menu in order for the consultation and manipulation of stored key words to be more efficient. It is possible to predict other representations, for example, of the kind described in the graphs 2a and 2b where the graphs are not a tree view.

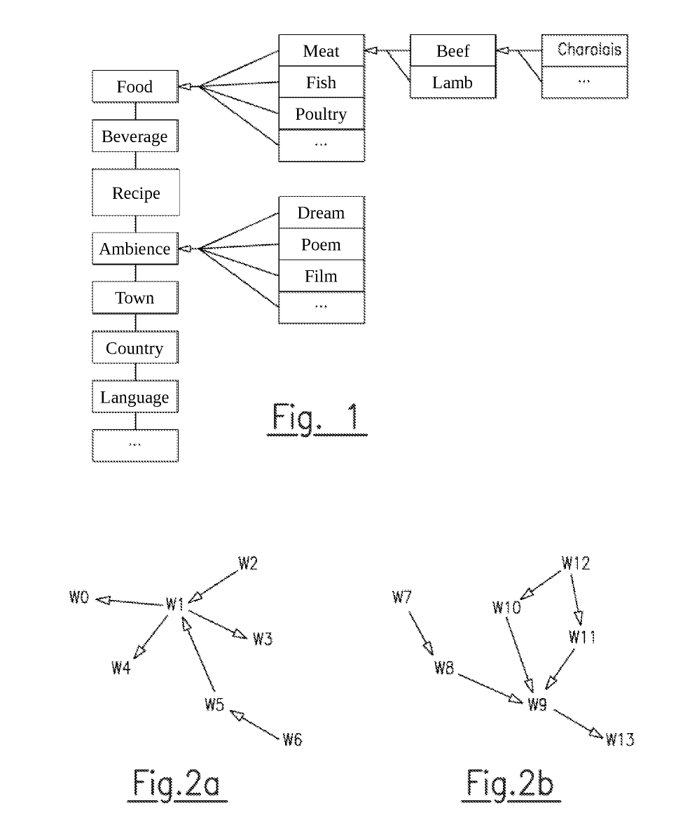

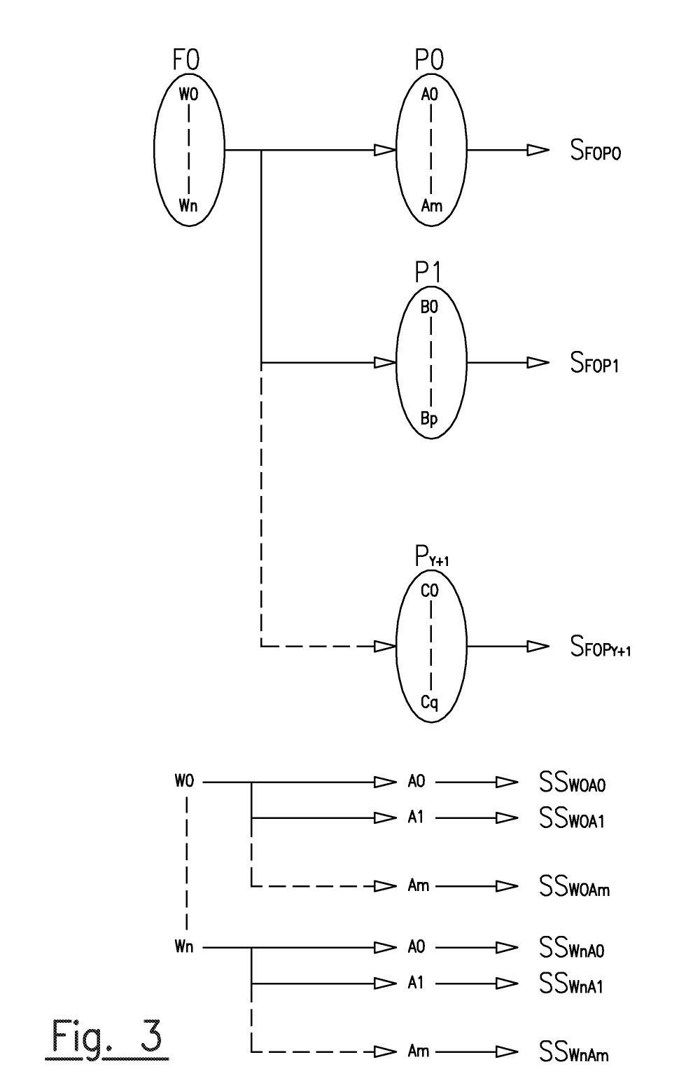

Referring to FIGS. 2a and 2b, the ontology graphs are, advantageously, directed graphs, preferentially directed acyclic graphs. On these figures, the references W0 to W13 correspond to key words in the ontology graph. Each key word of the ontology graph is related to one or more other key words of said graph.

By “directed graph”, one understands that the connection between the key words is preferentially directed according to the meaning of what is direction in the type of relation linking the aforementioned key words (for example, a word with a general meaning towards a word of particular meaning, . . . ). These directed connections are schematized by the arrows on the FIGS. 2a and 2b. These figures illustrate that according to the category or the subcategory of the graph, the key words can be arranged differently. In the same way, the same key words can have different relations according to the selected semantic field: “is a sub-category of”, “is contained in” “is greater than”, etc

By “acyclic graph”, one understands that the connections between the key words do not form a loop or a cycle. For example if one organizes key words W1, W2 and W3 in the following way W1→W2→W3, one avoids having W3→W1. One thus limits potential descriptions and the relations between the key words.

The invention is based on the analysis of the semantic proximity of a key words pair belonging to one or more ontology graphs. With this intention, a preferred method of calculating was developed by the applicant: one calculates, for each ontology graph, a score reflecting the semantic proximity between two words: Wo and Wr. This score lies between 0% (score=0, i.e. there does not exist a way of connecting the words Wo and Wr on the ontology graph) and 100% (score=1, i.e. the words Wo and Wr have the same exact meaning.

The score is preferentially calculated by using the following algorithm:

a) one calculates the topology distance on an ontology graph between the two words: d (Wo−Wr),
b) if one cannot measure the topological distance, then: score=0
c) if d(Wo−Wr)<0, then: score=C1/abs[d(Wo−Wr)], with abs[d(Wo−Wr)] corresponding to the absolute value of the topological distance d(Wo−Wr),
d) if d(Wo−Wr)>0 then: score=C2/abs[d(Wo−Wr)],
e) id d(Wo−Wr)=0 then: score=1, with C1 and C2 two predefined constants such as 0<C1<C2<1.

In practice, when the words Wo and Wr belong to several ontology graphs, one calculates a score on each graph and the score selected is the better of the calculated scores.

The constants C1 and C2 are defined so as to reflect the score when the distance d (Wo−Wr)=1, i.e. when the two words Wo and Wr are in direct relationship. The determination of these constants makes it possible to privilege the precision and the meaning of the request.

1^{st} example of the calculation of a score
Referring to the FIG. 2a, we calculate the score between W0 and W6 with:

W0 corresponding to the word “food”,

W6 corresponding to the word [symbol] Angus [symbol] ( [symbol] Angus [symbol] is a sub-category of [symbol] meat [symbol] ),

C1=0.125 and C2=0.5.

One calculates: D(W0−W6)=3 connections in the negative sense=
So: score=C1/abs[d(W0−W6)]=0.125/3=4.2%.
2nd example of the calculation of the score
In referring to the FIG. 2a, we calculate the score between W5 and W6 with:

W5 corresponding to the word “meat”,

W12 corresponding to the word [symbol] Angus [symbol] ( [symbol] Angus [symbol] is a sub-category of [symbol] meat [symbol] ),

C1=0.125 and C2=0.5.

One calculates: d(W5−W6)=1 relationship in the negative sense=−1
Therefore: score=C2/abs[d(W5−W6)]=0.125/1=12.5%.
The word “meat” is more precise than the word “food” and semantically closer to the word “Angus”, it is normal to have a score which is higher than that obtained by the previous example.
3rd example of the calculation of the score
Referring to the FIG. 2a, we calculate the score between W2 and W6 with:

W2 corresponding to the word “poultry”,

W2 corresponding to the word “angus”,

C1=0.125 and C2=0.5.

One cannot calculate the distance d(W2−W6) as there is no relationship between these two words. There is no way to allow the linkage of W2 to W6. One then has: score=0%
Being that there is no semantic link between the words “poultry” and “Angus”, it is normal to have a score of zero. This example highlights the concept of “semantics” which intervenes in the calculation method.
4th example of the calculation of a score
Referring to the FIG. 2b, we calculate the score between W12 and W9 with:

W12 corresponds to the word [symbol] Provence [symbol] ,

W9 corresponds to the word [symbol] Europe [symbol] ( [symbol] Provence [symbol] is a sub-category of [symbol] Europe [symbol] ),

C1=0.125 and C2=0.5.

We calculate: d(W12−W9)=2 relationships in the positive sense=+2
Therefore: score=C2/abs[d(W5−W6)]=0.5/2=25%.
5th example of the calculation of the score
In referencing the FIG. 2b, we calculate the score between W9 and W12 with:

W9 corresponding to the word [symbol] Europe [symbol] ,

W12 corresponding to the word <<Provence>> (<<Provence>> is a sub-category of [symbol] Europe [symbol] ),

C1=0.125 and C2=0.5.

We calculate: d(W9−W12)=2 relationships in the negative sense=−2
Therefore: score=C1/abs[d(W5−W6)]=0.125/2=6.25%.

The fourth and the fifth example clarify the dissymmetry of score which one can obtain because of the constants C1 and C2:

Score Provence-Europe≠Score Europe-Provence

This calculation method is therefore particularly easy to implement. Moreover, the calculated score reflects as precisely as possible and in an objective manner, the semantic proximity between the two words of a ontology graph. When there are several ontology graphs, the fact of only keeping the highest score allows the defining of the strongest semantic relationship linking the words. One thus optimizes the objective analysis of the semantic proximity of the words belonging to an ontology.

In a general way, one can note that the calculated score is inversely proportional to the number of connections separating the word pair (Wo−Wr) on the ontology graphs. It will be noticed that the latter are not necessarily directed, but in this case, the precision of the calculation is lesser. One could indeed envision one or more ontology graphs without connections directed between the key words, associated with the following algorithm:

a) on each ontology graph, one calculates the distance between the two words: d(Wo−Wr), i.e. the number of connections separating the aforementioned words,
b) If one cannot measure the distance: score=0
c) if d(Wo−Wr)=0 then: score=1,
d) in the other cases: score=C/d(Wo−Wr),
e) with C a preset constant such as 0<C<1,
f) the score retained being the best score calculated on each ontology graph.

The methods of calculating defined previously can be used in particular to improve the operation of search engines and in particular those used on the Internet. In a database corresponding to a semantic field for which one defines one or more ontology graphs, it is thus possible to envision a search engine having a processor that can carry out a computer program able to calculate such a score according to the algorithm defined previously.

In a more specific way, it is particularly advantageous to use this semantic analysis of words, to display on a computer screen the information associated with one or more key words. It is thus possible to improve upon a system of targeted advertisements by key words such as the system AdWords® by Google®. Moreover, it can be used, as will be described later in the description, for the operation of an Internet site system making it possible to connect various communities of Net surfers or various Net surfers inside the same community (Community site).

With this as the intention, one can establish beforehand a database containing the key words classified in one or more ontology graphs of the type described previously. Knowing the general architecture of ontology graphs, the latter as well as the database can be easily established by a professional in this field.

Customers, generally the sponsors or advertisers, associate information with a word group containing one or more key words chosen in the database and in particular in the ontology graph, these words being known as “required”. In a general way, a “required” word makes it possible to associate information with a product or a service that a customer is selling.

Preferably, the information is in the form of an advertising banner similar to those which one has with the AdWords® system by Google®. This information could also be a link to an Internet site, and/or a hypertext link, and/or a URL address, and/or a text, and/or an image, and/or a video message, and/or an audio message, and/or an instruction allowing the execution of a program, etc

In practice, one envisions an interface configured to allow the customers to associate information with a word group containing one or more key words chosen in the database and in particular in the ontology graphic/s. For example, a seller in high-end wines of Bordeaux (France) can define a group containing the following words: “wine”, “red”, “Bordeaux”, “chateau”, etc. This first word group could be associated with a link directed towards the Internet site of the seller or be associated with a banner ad for promoting this type of wine. In the same manner, another seller of high-end wines of California will also be able to define a second group containing the following words: “wine”, “red”, “California”, “Napa.”, etc. Referring to FIG. 3, the “required” words are gathered into groups P0, . . . , P _{Y+1}, each one of the aforesaid groups including one or more “required” words respectively, referring to A0-Am, . . . , C0-Cq.

When the customers logon to or connect to a specific Internet site configured to implement the invention, they have, advantageously, on their screen computer:
an access to the database and in particular to the ontology graph or graphs,
an interface allowing them to indicate the key words chosen,
an interface allowing them to associate information with this word group.

The customers have the possibility of directly supplementing the interface relating to the word group by selecting the latter directly on the ontology graphic/s.

The customers also have the possibility of contacting an operator of an Internet site in such a way as to indicate to the operator the associations of key words and information which they wish to carry out. In this case, the operator implements the associations necessary on behalf of the customers

When a user wishes to carry out a search, he is connected to an Internet site which has implemented the invention, and selects one or more key words chosen from the database, these words being known as “offered”. To do this, one envisions an interface configured to allow a user to select one or more key words chosen from the database, these words being known as “offered”. For example, the user will be able to select on the ontology graph/s the key words “alcoholic beverage”, “France” and “Pinot Noir” (the Pinot Noir being a type of grape characteristic of the wines of Burgundy, the word/term “Pinot Noir” is a subcategory of “Burgundy” in the ontology graph). In a general way, an “offered” word makes it possible to associate information with a product or a service which a user proposes and it can acquire from a client or from of one of his competitors. Referring to FIG. 3, the “offered” words correspond to the references Wo to Wn and are gathered in the F0 group.

As do the customers, the users have available on their computer screen access to the database and in particular to ontology graphic/s and an interface allowing one to indicate the key words selected.

It can be advantageous to combine the ontology graph/s with a search engine making it possible to quickly reach a category and/or a subcategory in the database, for example using a computer program able to carry out a syntactic comparison of the key word sought. The computer program used is well-known to any specialist in the profession. One can thus envision an interface allowing a user and/or a customer to enter the key word which he seeks into the ontology graph/s. When a user and/or a customer hit a specific key, the computer program automatically carries out a syntactic comparison between the required word and the key words in the ontology graph/s.

In the same way, it can be advantageous for the device to have a configured interface so that the customers and/or the users can supplement the ontology graphs with key words which are not initially present in the database and which are likely to enrich the vocabulary by the semantic field of the aforesaid database. However, it is preferable that a competent operator permanently check the new key words registered in graph/s so as to be able to move them and/or delete them if deemed necessary to the integrity of the ontological field in question.

In accordance with the invention and as represented on FIG. 3, for each P0 group, . . . , P Y+1, one analyzes the semantic proximity of the words “offered” W0-Wn and of the words “required” A0-Am, . . . , C0-Cq of the said group, by calculating a score S FOPO-S FOP Y+1 inversely proportional to the number of connections separating the aforementioned words on each ontology graph. In practice, a processor executes the computer program making it possible to calculate this score.

Each score S FOPO-S FOP Y+1 is calculated by realizing the partial-scores obtained for each word pair “offered” W0-Wn and of each “required” word A0-Am, . . . , C0-Cq. With this intention, the processor executes a computer program configured to calculate and realize such partial-scores. For example, and referring to FIG. 3, for the P0 group, one calculates all the partial-scores S W0A0-S WnAm on each ontology graph. We calculate then the score S FOPO by the following formula:

SFOPO=Σ(SSWiAj,i=0−n;j=0−m)/(n×m)

The partial-score are calculated based on the algorithm described previously:

on each ontology graph, one calculates the topology distance between an “offered” word Wo and a “required” word Wr: D (Wo−Wr),

if one cannot measure the topological difference, then: under-score=0,

if d(Wo−Wr)<0 then: partial-score=C1/abs[d(Wo−Wr)],

if d(Wo−Wr)>0 then: partial-score=C2/abs[d(Wo−Wr)],

if d(Wo−Wr)=0 then: partial-score=1,

with C1 and C2 two predefined constants such as 0<C1<C2<1,

the partial-score retained being the best of the partial-scores calculated on each ontological graph For example, for the word pair _{W0-A0}, in the case where a first ontology graph there is S W0A0=50% and on a second graph, S W0A0=10%, then one takes into account only the partial-score S W0A0=50% for the calculation of the score.

Preferably, it averages only the partial-score which are not zero in such a way as to not penalize the client. Indeed, if one takes into account a partial-score of zero, the value of the score will quickly fall and thus penalize the customers.

On the other hand, it is advantageous to average the partial-scores in order to handicap the customers who would misuse their financial capacity to buy a great number of poorly targeted, “required” words, incorrectly believing they would obtain a better score by doing so. Indeed, in general, “required” words are invoiced to the customers and using the average of the partial-scores makes it possible to handicap financially advantaged customers who could otherwise simply finance a great number of words.

Once all the scores S FOPO-S FOP Y+1 are calculated for each ontology graph, the information associated with the “required” word group is displayed, the one having the highest score, on the user's screen. This displaying is done by the intermediary of the computer application or other means well known to professionals.

Referring back to the example described previously where the customers are two wine merchants:

one of high-end wines of Bordeaux having registered in a first group the “required” words of: “wine”, “red”, “Bordeaux”, “chateau”,

the other of high-end wines of California having registered in a second group the “required” words of: “wine”, “red”, “California”, “Napa.”,

and where the user chooses the “offered” words of: “alcoholic drink”, “France” and “Pinot Noir” (the Pinot Noir being a type of grape characteristic of the wines of Burgundy, the word “Pinot Noir” is a subcategory of “Burgundy” on an ontology graph), the second group will have a score higher than that of the first group and information associated to this said second group will be displayed, in priority, on the user's screen.

As this was evoked in reference to the fourth and the fifth examples quoted previously, the calculation algorithm used makes it possible to obtain a dissymmetry in the scores. Let's take for example an ontology graph including the words “Wine”, “Bordeaux”, “Petrus”, classified according to the following relation: Vine-Bordeaux. Petrus (“Petrus” is a subcategory of “Bordeaux” which is subcategory of “Wine”).

In a first case where the user chooses as an “offered” word: “Petrus”, and where a customer chooses as a “required” word: “Wine”, one obtains the following score:

One calculates the distance d(Petrus−Wine)=+2

in placing C1=0.125 et C2=0.5

one obtains: S=0.5/2=25° A

In a second case where the user chooses as an “offered” word: “Wine”, and where a customer chooses as a “required” word: “Petrus”, one obtains the following score:

one calculates the distance d(wine−Petrus)=−2

in placing C1=0.125 and C2=0.5

one obtains: S=0.125/2=6

The score of the first case is more important than the score of the second case because it most accurately reflects the desire of the customer. Indeed, while seeking “Wine”, it is normal that “Petrus” would satisfy the request correctly. Conversely, while seeking “Petrus”, it is normal that “Wine” would satisfy the request less correctly.

While emphasizing the process and/or the dispositive which has just been described, one can conceive of many particularly attractive Internet systems. In particular, one can envision an Internet site system allowing guests wishing to take part in meals or food related events and hosts wishing to organize the aforementioned meals to connect. The hosts could propose to guests to welcome them on their premises to experience a culinary meal, tasting or other food related event, with the idea that the guests contribute financially to the costs of the event.

This Internet site system comprises, in particular, a database containing the key words related to the semantic field of gastronomy, the aforementioned key words being classified in one or more ontology graphs of the kind described previously and, for example, represented in FIG. 1

Access to the Internet site is accessible to the guests, the hosts (who are ideally also and initially “guests” in the system) and the customers who are typically advertisers.

When connecting to the Internet site, the hosts register, via an adapted interface and create a profile: last name, first name, age, address, country, language, etc. They are then asked to describe the type of meals or other food related events they wish to organize while specifying in particular:

the date of the meals or food related events, the location, the asking price (possibly), the number of desired guests, etc,

words most likely to describe or characterize the type of meals or events organized: dishes, origin of the dishes, ingredients used, etc. One envisions for this a configured interface allowing the hosts to select one or more key words chosen in the database, these words being known as “offered”. For each host, one has a word group containing one or more “offered” words.

The customers are also invited to create their profile and are directed to characterize the type of products or services which they would like to promote. In the same manner described previously, the customers have at their disposal a configured interface allowing them to associate information (typically an advertisement or a link to another Internet site) with a group containing one or more selected key words from the database, these words being known as “required”. Therefore, for each customer, one has a word group containing one or more “required” words.

In practice, the “required” words are invoiced: the more the group contains words, the more the customer will have to pay if the associated information is selected later on by a guest. The customers thus have the possibility of indicating, via an adapted interface or by contacting an operator, the maximum sum which they wish to spend over a given period. If the total sum is used up, the information will not be displayed.

A processor carries out a computer program making it possible to analyze, for each “required” word group and for each word group “offered”, the semantic proximity of the aforesaid words “offered” and of the aforesaid words “required” by calculating a score inversely proportional to the number of connections separating the aforementioned words on each ontology graph. The calculation method is identical to that described previously.

When the guests connect to the Internet site, they register, via an adapted interface, their profile: last name, first name, age, address, country, language, etc.

They are directed to characterize the type of meal or food related event in which they wish to take part while specifying in particular:

the date of the meal/event, the location, the number of guests they hope to find at the meal/event, . . . .

the words most likely to characterize the type of desired meal: dishes, drinks, ingredients used, cultural interests, etc. One envisions for this a configured interface allowing the guests to select one or more key words chosen in the database. Therefore, for each customer, one has a word group containing one or more “required” key words from the ontology graph. The guests have the possibility of using the operators of And/Or and And or Or to combine their key words.

A specific “search” key is then clicked by the guests once they have finished characterizing the meals/events in which they wish to participate. Consequently, the processor carries out a computer program making it possible to analyze the key words of the guests so as to select the meals organized by the aforementioned hosts and characterized by one or more key words chosen by the aforementioned guests. This can be done in this case by a simple syntax analysis.

But preferentially, the processor carries out a computer program making it possible to analyze, for each group of words selected by the hosts, the semantic proximity of the aforesaid words with the words chosen by the guests, by calculating a score inversely proportional to the number of connections separating the words on each ontology graph, the calculation method being identical to that described previously.

Thus, independent of the presence or non presence of customers, one can predict the Internet site system having:

a configured interface allowing the hosts to associate a meal or food related event that they wish to organize with a group containing one or more key words chosen in the database, these words being known as “required”,

an interface configured to allow the guests to select one or more key words chosen in the database, the aforementioned words being selected to characterize the type of meal or food related event desired, these words being known as “offered”,

a processor carrying out a computer program allowing the analysis for each“required” word group of the semantic proximity of the “offered” words and of the “required” words by calculating a score inversely proportional to the number of connections separating the words on each ontology graph,

a means to post, on the computer screen of the guests, the list of the meals or food related events associated with the “required” word groups having non zero scores.

In practice, according to the operators (AND, OR, AND/OR) chosen by the guest, the posted list will comprise the meals/events:

in which all words “offered” are semantically close or similar to the “required” words,

in which at least one of the words “offered” is semantically close or similar to the “required” words,

or in which certain “offered” words are semantically close or similar to the “required” words.

By “semantically near or similar”, one understands that the score between an “offered” word and a “required” word is greater than 0%.

With this type of list, it is possible to treat the meals/events on an hierarchical basis according to the scores obtained.

The selection of the meals/events can also be combined with the other criteria required by the guest but which are not inevitably key words in the database: date of the meals/events, place, number of guests they prefer present at the meal/event, etc. The selection of the meals/events is thus carried out by heterogeneous criteria, some of a semantic nature, others not.

All the meals/events (preferentially those which have a score that is not zero) are selected by the program so as to display them in the form of list, on the computer screens of the guests. This displaying is done by the intermediary of the computer applications or other means well known by IT professionals. The displayed list of meals/events allows the guests to be quickly informed of the meals/events in which they are likely to be interested. In theory, each meal/event appears as a hypertext link directing one towards a window describing in greater detail this time, the aforementioned meal/event: contact information of the host, place, date, number of guests, dishes, ingredients, etc.

In accordance with the invention, as soon as a guest selects a meal/event from the list, the information associated with the “required” word group having the highest score is displayed on the screen of the guest. This displaying is done by the intermediary of the computer applications or other means well known to IT professionals.

### Abridged Description

The invention relates to a process which makes it possible to display on a computer screen information associated with one or more key words and in which:

customers associate information with a word group containing one or more “required” key words selected from a database,

a user selects one or more key words “offered”, chosen from the database,

for each “required” word group, one analyzes the semantic proximity of the words “offered” and of the aforesaid “required” words by calculating a score inversely proportional to the number of connections separating the aforementioned words on an ontology graph, the aforementioned score being calculated by averaging the partial-scores obtained for each “offered” and “required” word pair, the aforementioned partial-scores being calculated according to the following algorithm:
on each ontology graph, one calculates the topology distance between an “offered” word and a “required” word: d (Wo−Wr),
if one cannot measure the topological distance then: partial-score=0
if d(Wo−Wr)<0 then: partial-score=C1/abs[d(Wo−Wr)],
if d(Wo−Wr)>0 then: partial-score=C2/abs[d(Wo−Wr)],
if d(Wo−Wr)=0 then: partial-score=1,
with C1 and C2 two predefined constants such as 0<C1<C2<1,
the partial-score retained being the best partial-scores calculated on each ontology graph,

one posts information associated with the “required” word group having the highest score.

No image

1. PROCEDURE ALLOWING THE DISPLAYING ON A COMPUTER SCREEN INFORMATION ASSOCIATED TO ONE OR SEVERAL KEY WORDS characterized by the facts that:
one establishes a database containing key words classified in one or more ontology graphs so that the aforementioned words are connected and organized according to semantics, each graph corresponding to a different type of relationship linking the aforementioned key words,
one directs the connections between key words in the ontology graph/s based on the concept of the direction of the relationship type of the aforementioned key words,
customers associate information with a word group containing one or more key words chosen in the database, these words being known as “required”,
a user selects one or more key words chosen from the database, these words being known as “offered”,
for the “required” word group, one analyzes the semantic proximity of the “offered” words and of the aforesaid “required” words by calculating a score, the aforementioned score being calculated by realizing the partial-scores obtained for each word pair of “offered” (Wo) and “required” (Wr) words, the aforementioned partial-scores being calculated according to the following algorithm:
on each ontology graph, one calculates the topology distance between an “offered” word and a “required” word: d (Wo−Wr), in other words, the number of linkages between Wo and Wr when they are all oriented in the same direction, one gives to d(Wo,Wr) a positive sign if the linkages are oriented from Wo to Wr, if not then one gives a negative sign to d(Wo,Wr).
if one cannot measure the topological distance, then: partial-score=0
if d(Wo−Wr)<0 then: partial-score=C1/abs[d(Wo−Wr)],
if d(Wo−Wr)>0 then: partial-score=C2/abs[d(Wo−Wr)],
if d(Wo−Wr)=0 then: partial-score=1,
with C1 and C2 two predefined constants such as 0<C1<C2<1,
the partial-score retained being the best partial-scores calculated on each ontology graph,
one displays information associated with the “required” word group having the highest score, on the user's screen.

2. Process according to claim 1, in which one averages only the non zero partial-scores in order to calculate the score reflecting the semantic proximity between the “offered” and “required” word in a group.

3. PROCEDURE ALLOWING THE DISPLAYING ON A COMPUTER SCREEN INFORMATION ASSOCIATED TO ONE OR SEVERAL KEY WORDS characterized by the fact that they contain:
a database containing key words classified in one or more ontology graphs so that the aforementioned words are connected to one another and organized according to semantics, each graph corresponding to a different type of relationship linking the aforementioned key words, the connections between the aforementioned key words in the ontology graph/s being based on the concept of the direction of the relationship type linking the aforementioned key words,
customers associate information with a word group containing one or more key words chosen in the database these words being known as “required”,
a configured interface allowing a user to select one or more key words chosen from the database, these words being known as “offered”,
a processor executing a computer program, for the “required” word group, to analyze the semantic proximity of the “offered” words and of the aforesaid “required” words by calculating a score, the aforementioned processor calculating the score executing a computer program configured to calculate and average the partial-scores obtained for each word pair of “offered” (Wo) and “required” (Wr) words, the aforementioned partial-scores being calculated according to the following algorithm:
on each ontology graph, one calculates the topology distance between an “offered” word and a “required” word: d (Wo−Wr), in other words, the number of linkages between Wo and Wr when they are all oriented in the same direction, one gives to d(Wo,Wr) a positive sign if the linkages are oriented from Wo to Wr, if not then one gives a negative sign to d(Wo,Wr).
if one cannot measure the topological distance then: partial-score=0
if d(Wo−Wr)<0 then: partial-score=C1/abs[d(Wo−Wr)],
if d(Wo−Wr)>0 then: partial-score=C2/abs[d(Wo−Wr)],
if d(Wo−Wr)=0 then: partial-score=1,
with C1 and C2 two predefined constants such as 0<C1<C2<1,
the partial-score retained being best partial-scores calculated on each ontology graph,
a means to display information associated with the “required” word group having the highest score, on the user's screen.

4. Dispositive according to claim 3, in which the computer program averages only non zero partial-scores.

5. Dispositive according to one of claim 3 or 4, comprising a configured interface so that the customers and/or the users can supplement the ontology graphs with key words which are not initially present in the database.

6. Dispositive according to one of claims 3 to 5, in which the information posted on the screen is an advertising banner and/or a link to an Internet site, and/or a hypertext link, and/or an address URL, and/or a text, and/or an image, and/or a video message, and/or a message audio, and/or an instruction allowing the execution of a program.

7. Dispositive according to one of the claims 3 to 6, in which the ontology graph or graphs are directed acyclic graphs.

8. Dispositive according to one of the claims 3 to 7, in which the key words classified in the ontology graph or graphs all have an entirely different syntax.

9. System of Internet site allowing the connection of guests wishing to take part in meals/events and hosts wishing to organize the aforementioned meals/events, characterized in that it comprises in particular a device in conformity with claim 3 and in particular:
a database containing the key words in relation to the semantic field the gastronomy, the aforementioned words being classified in one or more ontology graphs so that the aforementioned words are connected and organized amongst-themselves according to semantics, each graph corresponding to a type of different relationship linking the aforementioned key words, the connections between the aforementioned key words of the ontology graph or graphs being directed according to the direction of the type of relation linking the aforementioned key words,
a configured interface for allowing hosts to associate a meal or food related event that they wish to organize to a group containing one or more key words chosen in the database, these words being known as “offered”,
an interface configured to allow the guests to select one or more key words chosen in the database, the aforementioned words being selected to characterize the type of meal or food related event desired,
a configured interface allowing customers associate information with a word group containing one or more key words chosen in the database these words being known as “required”,
a processor executing a computer program allowing:
the analysis of key words of the guests so as to select the meals organized by the aforementioned hosts and characterized by one or more key words chosen by the aforementioned guests,
to analyze, for the word group “required” and for each word group “offered”, the semantic proximity of the aforesaid “offered” words and of the aforesaid “required” words by calculating a score, the aforementioned score being calculated by realizing the partial-scores obtained for each “offered” (Wo) and “required” (Wr) word pair, the aforementioned partial-scores being calculated according to the following algorithm:
on each ontology graph, one calculates the topology distance between an “offered” word and a “required” word: d (Wo−Wr), in other words, the number of linkages between Wo and Wr when they are all oriented in the same direction, one gives to d(Wo,Wr) a positive sign if the linkages are oriented from Wo to Wr, if not then one gives a negative sign to d(Wo,Wr).
if one cannot measure the topological distance, then: partial-score=
if d(Wo−Wr)<0 then: partial-score=C1/abs[d(Wo−Wr)],
if d(Wo−Wr)>0 then: partial-score=C2/abs[d(Wo−Wr)],
if d(Wo−Wr)=0 then: partial-score=1,
with C1 and C2 two predefined constants such as 0<C1<C2<1,
the partial-score retained being the best partial-scores calculated on each ontology graph,
a means to display, on the computer screen of the guests, the list of the selected meals or food related events, each meal or food related event appearing as a hypertext link returning to a window describing in greater detail the aforementioned meal or food related event,
a means to display information associated with the “required” word group having the highest score, on the screen of the guests having selected a meal or food related event from the list.

10. Internet site system allowing the connection of guests wishing to take part in meals/events and hosts wishing to organize the aforementioned meals/events, characterized in that it comprises in particular a device in conformity with claim 3 and in particular:
a database containing the key words in relation to the semantic field of gastronomy, the aforementioned words being classified in one or more ontology graphs so that the aforementioned words are connected and organized amongst-themselves according to semantics, each graph corresponding to a type of different relationship linking the aforementioned key words, the connections between the aforementioned key words of the ontology graph or graphs being oriented according to the direction of the type of relationship linking the aforementioned key words,
a configured interface allowing the hosts to associate a meal or food related event that they wish to organize with a group containing one or more key words chosen in the database, these words being known as “required”,
an interface configured to allow the guests to select one or more key words chosen in the database, the aforementioned words being selected to characterize the type of meal or food related event desired, these words being known as “offered”,
a processor executing a computer program, for the “required” word group, to analyze the semantic proximity of the “offered” words and of the aforesaid “required” words by calculating a score, the aforementioned processor calculating the score by executing a computer program configured to calculate and average the partial-scores obtained for each word pair of “offered” (Wo) and “required” (Wr) words, the aforementioned partial-scores being calculated according to the following algorithm:
on each ontology graph, one calculates the topology distance between an “offered” word and a “required” word: d (Wo−Wr), in other words, the number of linkages between Wo and Wr when they are all oriented in the same direction, one gives to d(Wo,Wr) a positive sign if the linkages are oriented from Wo to Wr, if not then one gives a negative sign to d(Wo,Wr).
if one cannot measure the topological distance, then: partial-score=0
if d(Wo−Wr)<0 then: partial-score=C1/abs[d(Wo−Wr)],
if d(Wo−Wr)>0 then: partial-score=C2/abs[d(Wo−Wr)],
if d(Wo−Wr)=0 then: partial-score=1,
with C1 and C2 two predefined constants such as 0<C1<C2<1,
the partial-score retained being the best partial-score calculated on each ontology graph,
a means to display, on the computer screen of the guests, the list of the meals or food related events associated with the word groups “required” having non zero scores.

11. Search engine characterized by it comprising a processor that carries out a computer program to calculate a score reflecting the semantic proximity between two words,
the latter belonging to a database containing the key words classified in one or more ontology graphs
the aforementioned ontology graphs being managed in such a way that the key words are organized according to semantics and various relationships linking the aforementioned key words
the said program calculating the said score according to the following algorithm:
calculate the topological distance of each ontology graph between the said words: d(Wo−Wr)
if the topological distance is not measurable, then: score=0,
if d(Wo−Wr)<0 then: score=C1/abs[d(Wo−Wr)],
if d(Wo−Wr)<0 then: score=C2/abs[d(Wo−Wr)],
if d(Wo−Wr)=0 then: score=1,
with C1 and C2 two predefined constants such as 0<C1<C2<1,
the score retained being the best score calculated on each ontology graph.
